(19) United States
(12) Patent Application Publication
(10) Pub. No.: US 2006/0143211 A1
(43) Pub. Date: Jun. 29, 2006

(54) Method and system for managing data storage for dynamically changing data area attribute

(76) Inventor: Norihiro Hara, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/074,715

(22) Filed: Mar. 9, 2005

(30) Foreign Application Priority Data
Dec. 10, 2004 (JP) 2004-358469

(51) Int. Cl. G06F 17/00

(52) U.S. Cl. 707/101

(57) ABSTRACT

This invention provides a storage system that can dynamically change an attribute of a logical device for storing data. A storage is configured by a database storage area. The database storage area includes a plurality of attributes of memories. A storage management unit includes a read/write unit for reading and writing data from and to a storage, in accordance with a request from a database management unit, and an attribute control unit for allocating the database storage area of the storage to any of the attribute of the memory. The attribute control unit changes the attribute of the memory allocated to the database storage area to a different attribute, if an attribute change instruction is included in the request from the storage management unit.

### CLAIM OF PRIORITY

The present application claims priority from Japanese application P2004-358469 filed on Dec. 10, 2004, the content of which is hereby incorporated by reference into this application.

### BACKGROUND

This invention relates to a storage system to which a work flow is applied, and more particularly to a computer system that can dynamically changing data area attribute of a logical device.

Conventionally, an E-Commerce system based on a work flow has a flow of a series of processes for receiving an order of a client, collecting articles based on the order, preparing a delivery plan, and carrying out a procedure for a payment after the delivery, and then sending an e-mail indicative of shipment and payment completion to the client. In this series of processes, the processes flow while updating information to data (form) stored in a database or the like (for example, refer to Japanese Patent Application No. 2002-25839).

Information requiring assurance of security, information requiring a high access speed, and the like are added to this form along with the advancement of the process.

### SUMMARY

In the E-Commerce system, along with the advancement of the process of the work flow (also referred to as a business process) as mentioned above, it is desired to change the attributes such as a security and an access speed, which are required for the data of a process target. This attribute cannot be changed on a data basis, and it is necessary to change the attribute of a memory (for example, a logical device) for storing the data. However, in order to change the attribute of the memory for storing the data, a process of a format of the memory or the like is required, which is impractical.

This invention has been made in view of the above-mentioned problems. It is therefore an object of this invention to provide a computer system that can dynamically change attributes of a memory for storing data, in response to a process of an application based on a work flow. This invention provides a storage management apparatus for reading and writing data from and to a storage for storing a database in accordance with a request from a database management apparatus for managing the database, the storage including a database storage area, and the database storage area including memories of a plurality of attributes, the storage management apparatus including: a reading/writing unit for reading and writing the data from and to the storage in accordance with the request from the database management apparatus; and an attribute control unit for allocating the database storage area of the storage to the memories of any of the attributes, in which the attribute control unit changes the attribute of the memory allocated to the database storage area to a different attribute, when an attribute change instruction is included in the request from the storage management apparatus.

According to this invention, the memory (logical device) allocated to the database storage area (logical unit) of the storage can be dynamically changed in response to the instruction from outside a storage system.

### BRIEF DESCRIPTION OF THE DRAWINGS

FIG. 1 is a block diagram showing a process of a computer system according to an embodiment of this invention.

FIG. 2 is a functional block diagram showing the computer system according to the embodiment of this invention.

FIG. 3 is a block diagram showing a hardware configuration of the computer system according to the embodiment of this invention.

FIG. 4 is an explanatory diagram showing a category change table according to the embodiment of this invention.

FIG. 5 is an explanatory diagram showing a table and DB area definition table according to the embodiment of this invention.

FIG. 6 is an explanatory diagram showing a DB area information table according to the embodiment of this invention.

FIG. 7 is an explanatory diagram showing an LU category management table according to the embodiment of this invention.

FIG. 8 is an explanatory diagram showing a category information table according to the embodiment of this invention.

FIG. 9 is an explanatory diagram showing an LDEV category information table according to the embodiment of this invention.

FIG. 10 is a flowchart of a table registration process of a database management system according to the embodiment of this invention.

FIG. 11 is a flowchart of an LU allocation process of a storage management unit according to the embodiment of this invention.

FIG. 12 is a flowchart of a data insertion process of the database management system according to the embodiment of this invention.

FIG. 13 is a flowchart of a data update process of the database management system according to the embodiment of this invention.

FIG. 14 is a flowchart of a data write process of a storage management unit according to the embodiment of this invention.

FIG. 15 is a flowchart of a data read process of the storage management unit according to the embodiment of this invention.

FIG. 16 is an explanatory diagram showing an LU category management table of a modified example of the embodiment of this invention.

### DETAILED DESCRIPTION OF THE PREFERRED EMBODIMENT

An embodiment of this invention will be described below in detail with reference to the drawings.

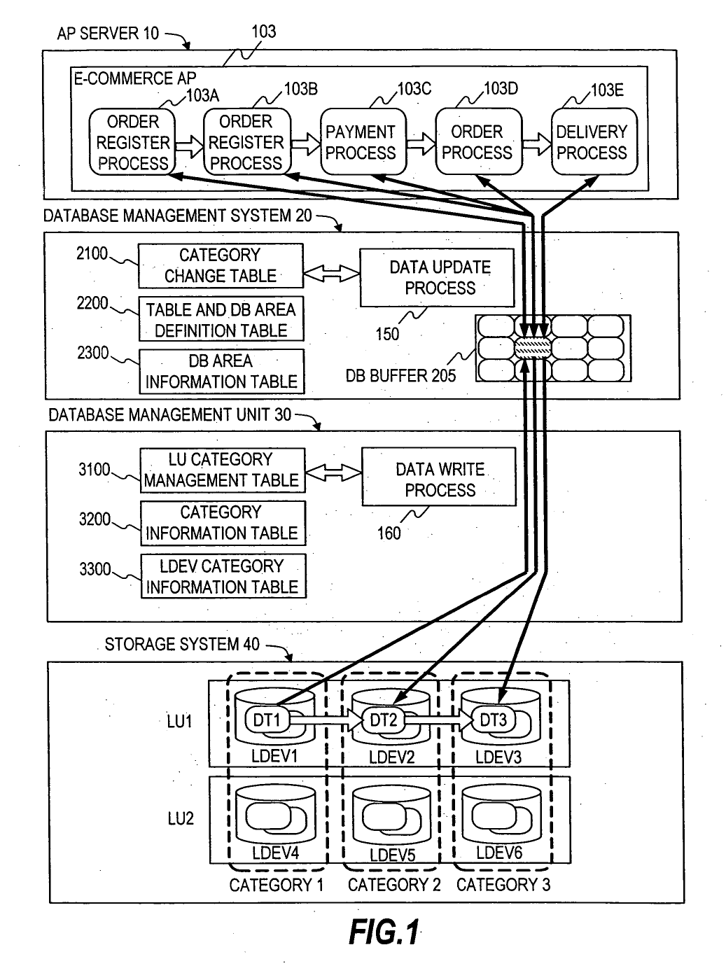

FIG. 1 is a block diagram showing a process of a computer system according to the embodiment of this invention.

On an application program server (hereafter, AP server) 10, an application program (a task program, a program, and an object are allowable) for accessing a database is run. In the example of FIG. 1, an E-Commerce application program 103 for attaining the E-Commerce is run on the AP server 10.

The E-Commerce AP 103 includes five processes of an order register process 103A, an order approval process-103B, a payment process 103C, an order process 103D and a delivery process 103E. The sequential execution of those processes offers the work flow (also referred to as the business flow).

A database management system 20 accesses a database stored in a storage system 40, in accordance with a request from an application of the AP server 10.

The database management system 20 executes a data update process.

A data update process unit 150 monitors whether or not there is an update of data in the database in a DB buffer 205 by use of the application of the AP server 10. Also, it is judged which row of which table of the database the updated data belongs to.

The database management system 20 has a category change table. 2100, a table and DB area definition table 2200 and a DB area information table 2300.

The category change table 2100 stores the kind of an operation from the application of the AP server 10 and a location of the data in the database of the operation target (i.e., the row in the table of the database).

The table and DB area definition table 2200 stores a table of the database and a storage area name of the database.

The DB area information table 2300 stores a storage area of the database and an LU name of the storage system 40.

A storage management unit 30 executes a data write process.

A data write process unit 160 receives an access to the storage system 40 from the database management system 20 and determines which logical device (LDEV) belonging to the logical unit (LU) corresponding to the request. Then, an access destination of the received access is determined as the detected LDEV.

The storage management unit 30 is provided with an LU category management table 3100, a category information table 3200 and an LDEV category information table 3300.

The LU category management table 3100 stores the LU, the LDEV in the storage system 40, and a change order of the category.

The category information table 3200 stores the information of the category set in the storage system 40.

The LDEV category information table 3300 stores the correspondence between the LDEV, the attribute (category) set for the LDEV, and a usage state of the LDEV.

In the storage system 40, a plurality of logical devices (LDEVs) are configured by RAID configuration and the like from a plurality of hard disks. Then, one or more LDEVs are allocated to any logical unit (LU).

The database management system 20, when accessing the storage system 40, uses this LU as the access destination. The storage management unit 30 determines the LDEV, which stores the data corresponding to the request, from the LU specified as the access destination.

In the storage system in this embodiment, a plurality of LDEVs are allocated to the LU. The plurality of LDEVs are set in “categories” different from each other.

The category indicates the attribute of the LDEV. For example, it is a level of access speed, a security, a reliability (redundancy), or the like.

In the work flow, the attributes required for the LDEVs storing the data that becomes the operation targets at the respective process stages are different from each other. Therefore, in order to enable change of this attribute as necessary, by changing the LDEV storing the data, it is possible to improve the process efficiency and reliability in the work flow.

In the example of FIG. 1, the storage system 40 is provided with two LUs (LU1, LU2), and each LU is classified into three categories. In other words, the LU1 is composed of an LDEV1 of a category 1, an LDEV2 of a category 2 and an LDEV3 of a category 3.

The AP server 10 accesses the database through a DB buffer 205 of the database management system 20. A specific process will be given below.

If there is a read request to read data from a row in a table of the database from the AP server 10, the database management system 20 obtains a database area to which the table corresponding to the request, by referring to the table and DB area definition table 2200. Moreover, the database management system 20 refers to the DB area information table 2300 and obtains the LU in the storage system 40 in which the obtained database area is stored.

Next, the database management system 20 reads the data of the row, which is stored in the obtained LU, from the storage system 40 and stores in the DB buffer 205. Then, the database management system 20 transmits the data of the row, which is stored in the DB buffer 205, to the AP server 10.

Also, if there is a write request to write data to a row in a table of the database from the AP server 10, the database management system 20 once stores a write data corresponding to the request in the DB buffer 205. Next, the database management system 20 refers to the table and DB area definition table 2200 and obtains a database area to which the table corresponding to the request. Moreover, the database management system 20 refers to the DB area information table 2300 and obtains the LU in the storage system 40 in which the obtained database area is stored.

Next, the database management system 20 defines the obtained LU as a write destination, and writes the data stored in the DB buffer 205 to the storage system 40.

Also, if there is an update request to data of the database from the AP server 10, the database management system 20 once stores the update data corresponding to the request in the DB buffer 205. Next, the database management system 20 refers to the table and DB area definition table 2200 and obtains the database area to which the table corresponding to the request belongs. Moreover, the database management system 20 obtains the LU in the storage system 40 in which the obtained database area is stored, by referring to the DB area information table 2300.

Next, the database management system 20 reads the data (pre-update data) stored in the obtained LU from the storage system 40, and stores in the DB buffer 205. Then, the database management system 20 updates the pre-update data stored in the DB buffer 205 in accordance with the request. Consequently, the update data is stored in the storage system 40.

At the time of the update of this data, the data update process 150 obtains which operation the application of the AP server 10 performs on which row of which table of the database. Then, the data update process 150 compares the obtained content with the category change table 2100 and judges whether or not it is the operation for changing the category.

The data update process 150, if judging that it is the operation for changing the category, determines to transmit a “Category Change Request” to the storage management unit 30.

Next, the database management system 20 defines the LU reading the pre-update data as a write destination and writes the post-update data stored in the DB buffer 205 to the storage system 40. At this time, if the category change request is determined to transmit, a category change instruction is added to the write request of the post-update data, and it is transmitted to the storage management unit 30.

A data write process 160 of the storage management unit 30 receives the category update request. The data write process 160, if judging that the category change request is added, changes the category. To be specific, the data write process 160 refers to the LU category management table 3100, obtains the LDEV of the changed category in accordance with a category change order, and determines the obtained LDEV as the write destination of the data.

Next, the process of the E-Commerce AP 103 of the AP server 10 is explained.

The E-Commerce AP 103 sequentially executes the five processes of the order register process 103A, the order approval, process 103B, the payment process 103C, the order process 103D and the delivery process 103E. These processes are sequentially executed, thereby offering the work flow.

At first, the order register process 103A is executed. In the order register process 103A, the update process is performed on a required data in the database, and this data is defined as DT1. This DT1 is stored in the LDEV of the category 1 belonging to the LU 1 of the storage system 40.

The order approval process 103B is executed after the order register process 103A. The order approval process 103B processes the DT1 that is the data processed by the order register process 103A.

In the order approval process 103B, the category 2 that is the category having a high security level is preset as a data storage destination.

The data update process 150 refers to the category change table 2100 and judges the change of the category storing the post-update data, in accordance with the update of the data by the order approval process 103B. Then, a category update instruction is generated.

The database management system 20 transmits the category update instruction together with the write request of the updated data to the storage management unit 30.

The storage management unit 30 receives this write request. The data write process 160 of the storage management unit 30, when receiving the category update instruction, refers to the LU category management table 3100 and obtains an LDEV2 corresponding to the category 2 of the write destination of the write request data. The storage management unit 30 determines the obtained LDEV2 as the write destination of the data. Then, it writes the request data to the LDEV2. This data is defined as DT2.

Next, the payment process 103C and the order process 103D are executed. These payment process 103C and order process 103D process the DT2 that is the data updated by the order approval process 103B.

In the payment process 103C and order process 103D, the category 2 that is the category having the high security level is preset as the data storage destination.

The data update process 150 refers to the category change table 2100 and judges that the category storing the post-update data is not changed as regards the update of the data caused by the payment process 103C and order process 103D because the category is already changed to the category 2. Thus, the category update instruction is not generated. In other words, the update data caused by the payment process 103C and order process 103D is stored in the LDEV2 of the category 2.

Next, the delivery process 103E is executed. The delivery process 103E processes the DT2 that is the data updated by the payment process 103C and order process 103D.

In the delivery process 103E, the category 3 that is the category having a high access speed is preset as the data storage destination.

The data update process 150 refers to the category change table 2100, and judges as regards the update of the data by the delivery process 103E that the category storing the post-update data is updated. Then, the category update instruction is generated.

The database management system 20 transmits the category update instruction together with the write request of the updated data to the storage management unit 30.

The storage management unit 30 receives this write request. The data write process 160 of the storage management unit 30, when receiving the category update instruction, refers to the LU category management table 3100 and obtains the LDEV3 corresponding to the category 3 of the write destination of the write request data. The storage management unit 30 determines the obtained LDEV3 as the write destination of the data. Then it writes the request data to the LDEV3. This data is defined as DT3.

In this way, depending on the process content and process target of the process of the work flow, the category of the data stored in the storage system 40 is sequentially changed.

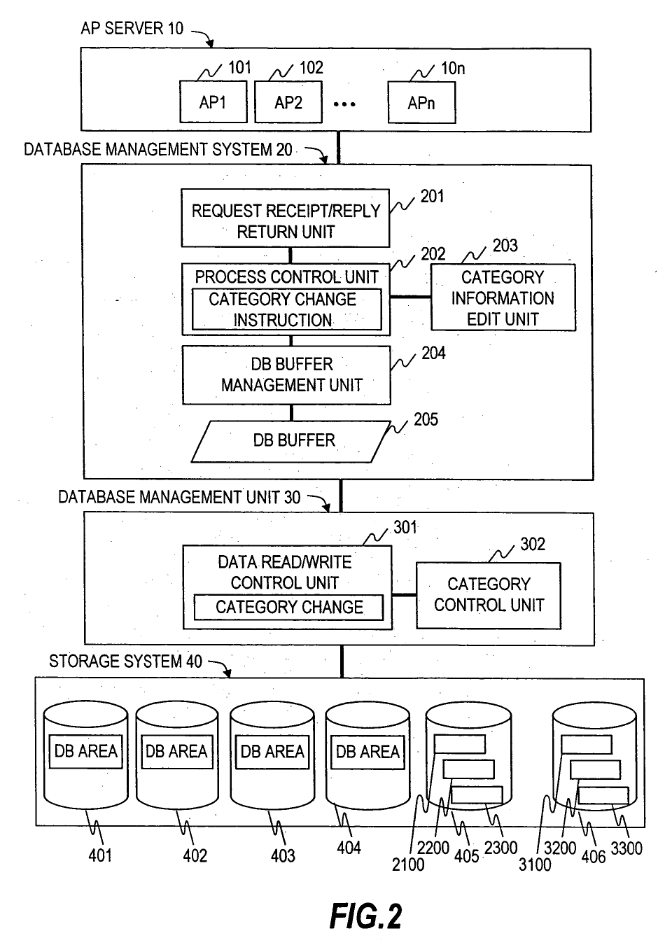

FIG. 2 is a functional block diagram showing the computer system according to the embodiment of this invention.

The AP server 10 stores applications (AP101, AP102 to AP10n) for executing a work flow process.

The database management system 20 has a request receipt/reply return unit 201, a process control unit 202, a category information edit unit 203, a DB buffer management unit 204 and a DB buffer 205.

The request receipt/reply return unit 201 is the interface. It receives the requests from the AP server. 10, the storage management unit 30 and the storage system 40 and returns the reply of the request.

The process control unit 202 executes the process in the database management system 20. To be specific, it executes the process based on the request received by the request receipt/reply return unit 201 and returns the execution result through the request receipt/reply return unit 201 to a source generated the request.

The category information edit unit 203 processes for editing a definition of a correspondence between the database area and the LU, a definition of a correspondence between the table and the database area, a setting of the category, and the like.

The DB buffer management unit 204 manages the storing of the data to the DB buffer 205.

The storage management unit 30 has a data read/write control unit 301 and a category control unit 302.

The data read/write control unit 301 receives the read request and write request of the data from the database management system 20 and performs the requested process on the storage system 40.

The category control unit 302 controls the information of the category set for the LDEV of the storage system 40.

The storage system 40 has database storage areas 401 to 404, a database management system table storage area 405 and a storage management unit table storage area 406. These areas are configured by one or more LUs.

The database management system table storage area 405 stores the category change table 2100, the table and DB area definition table 2200 and the DB area information table 2300.

The storage management unit table storage area 406 stores the LU category management table 3100 and the category information table 3200.

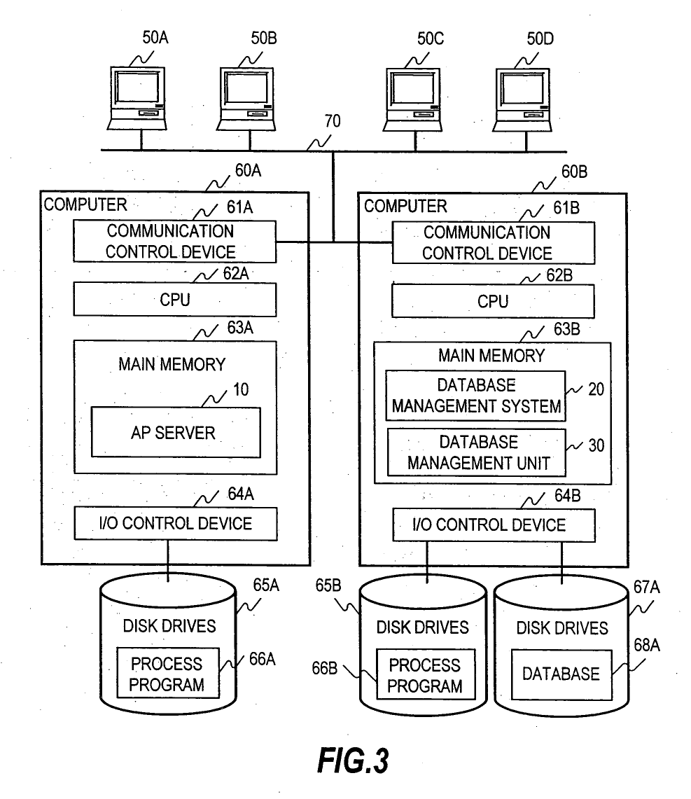

FIG. 3 is a block diagram showing a hardware configuration of the computer system according to the embodiment of this invention.

A plurality of host computers 50A, 50B, 50C and 50D are connected to a network 70. Also, computers 60A, 60B are connected to the network 70. This host computer 50 sends the request to the AP server 10 executed in the computer 60A and receives the result of the request.

The computer 60A has a communication control device 61A, a CPU 62A, a main memory 63A and an I/O control device 64A. Also, a disk drive 65A is connected through the I/O control device 64A.

The communication control device 61A transmits and receives the data through the network 70 to and from the host computer 50 or another computer 60B.

The CPU 62A loads a process program 66A stored in the disk drive 65A to the main memory 63A. The CPU 62A executes this process program 66A and consequently executes the process defined by the process program. In the example of FIG. 3, the main memory 63A stores the AP server 10, and the CPU 62A executes this. Consequently, the computer 60A functions as the AP server 10.

The main memory 63A stores the program and the temporally data.

The I/O control device 64A transmits and receives the data to and from the disk drive 65A.

The disk drive 65A is configured by the hard disk. The disk drive 65A stores the process program 66A.

The computer 60B has a communication control device 61B, a CPU 62B, a main memory 63B and an I/O control device 64B. Also, disk drives 65B and 67B are connected through the I/O control device 64B.

The communication control device 61B transmits and receives the data through the network 70 to and from the host computer 50 or another computer 60A.

The CPU 62B loads a process program 66B stored in the disk drive 65B to the main memory 63B. The CPU 62B executes this process program 66B, thereby executing the process defined by the process program. In the example of FIG. 3, the main memory 63B stores the database management system 20 and the storage management unit 30, and the CPU 62B executes this. Thus, the computer 60B functions as the database management system 20 and the storage management unit 30.

The main memory 63B stores the program and the transient data.

The I/O control device 64B transmits and receives the data to and from the disk drive 65B and the disk drive 67B.

The disk drive 65B is configured by the hard disk. The disk drive 65B stores the process program 66B.

The disk drive 67B is configured by the hard disk. The disk drive 67B stores a database 68B.

It should be noted that, in FIG. 3, although the storage management unit 30 is illustrated as the process program of the computer 60B, the other configuration is allowable. For example, it may be included in the disk drive 67B. Also, it may be attained as the process program of the other computer 60. Also, it may be attained as the hardware of the other computer 60.

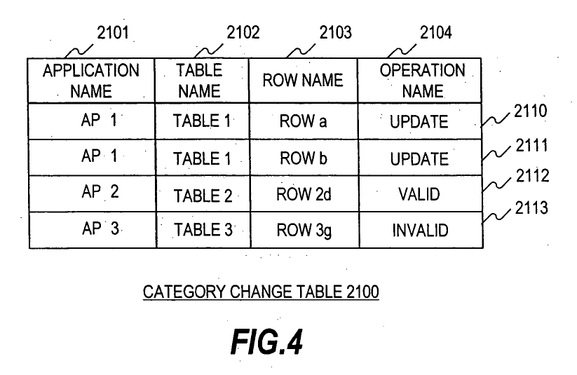

FIG. 4 is an explanatory diagram showing the category change table 2100 according to the embodiment of this invention.

The category change table 2100 is composed of an application name 2101, a table name 2102, a row name 2102 and an operation name 2104.

The application name 2101 stores an identifier of the application for operating the data.

The table name 2102 stores an identifier of the table to which the data of the operation target belongs.

The row name 2103 stores an identifier of the row to which the data of the operation target belongs.

The operation name 2104 stores an identifier of the content of the operation carried out by using the application. For example, “Update” indicates that the operation applied to the row data is the update of the data.

The data update process 150 of the database management system 20, in response to the operation request from the application of the AP server 10 to the database, obtains the application name, the table and row of the database of the operation target, and the content of the operation, from the operation request. Then, the data update process 150 compares the obtained content with the category change table 2101. As a result of comparison, if the obtained information is coincident with any of entries of the category change table 2100, the data update process 150 determines to transmit the category change instruction for instructing the change of the category to the storage management unit 30.

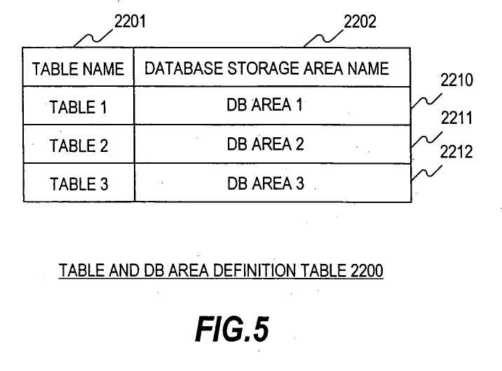

FIG. 5 is an explanatory diagram showing the table and DB area definition table 2200 according to the embodiment of this invention. The table and DB area definition table 2200 is composed of a table name 2201 and a DB area 2202.

The table name 2201 stores an identifier of the table, and the DB area 2202 stores an identifier of the area of the database.

The database management system 20 can obtain the database area to which the table of the database belongs, by referring to this table and DB area definition table 2200.

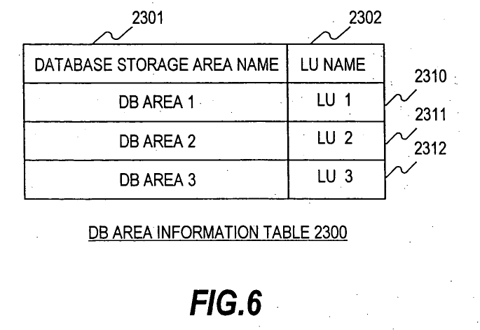

FIG. 6 is an explanatory diagram showing the DB area information table 2300 according to the embodiment of this invention.

The DB area information table 2300 is composed of a DB area 2301 and an LU name 2302.

The DB area 2301 stores an identifier of the area of the database, and the LU name 2302 stores an identifier of the LU.

The database management system 20 can obtain the LU of the storage system 40 to which the database area belongs, by referring to this DB area information table 2300.

In other words, by referring to the table and DB area definition table 2200 of FIG. 5 and the DB area information table 2300 of FIG. 6, the database management system 20 can obtain the table of the database to which the database area belongs and can obtain the LU of the storage system 40 to which the database area belongs.

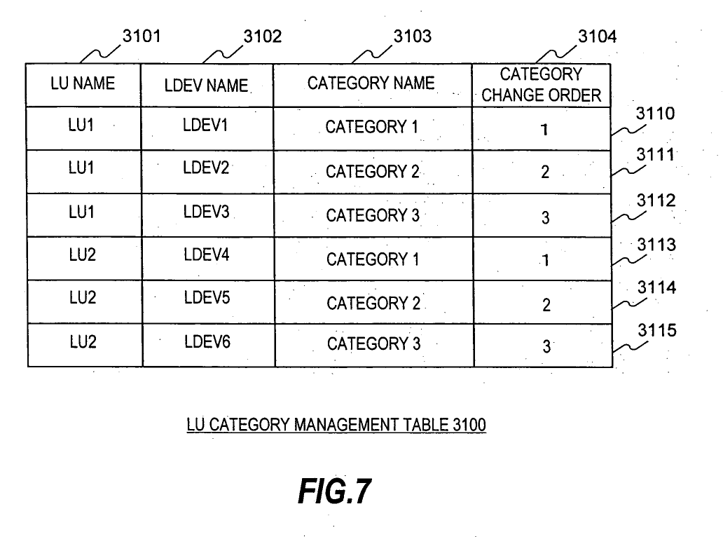

FIG. 7 is an explanatory diagram showing the LU category management table 3100 in the embodiment of this invention.

The LU category management table 3100 is composed of an LU name 3101, an LDEV name 3102, a category name 3103, and a category change order 3104.

The LU name 3101 stores an identifier of the LU.

The LDEV name 3102 stores an identifier of the LDEV.

The category name 3103 stores a category name set for the LDEV.

The category change order 3104 stores a change order of a plurality of categories set for the LU.

When receiving the category change instruction from the database management system 20, the data write process 160 of the storage management unit 30 changes the category of the access destination, in accordance with this category change order, and determines the LDEV of the write target of the data.

The request of the access destination to the database from the database management system 20 is instructed as the LU. Any one of the LDEVs indicated by this LU category management table 3100 is allocated to this LU by the storage management unit 30. If the storage management system 20 transmits the category change instruction, the LDEV is changed in accordance with the category change order, and the changed LDEV is allocated to a new LDEV. As a result, it is possible to change the category, in other words, the attribute of the LDEV, by changing the allocation of the LDEV without changing the LU that is the access destination from the database management system 20.

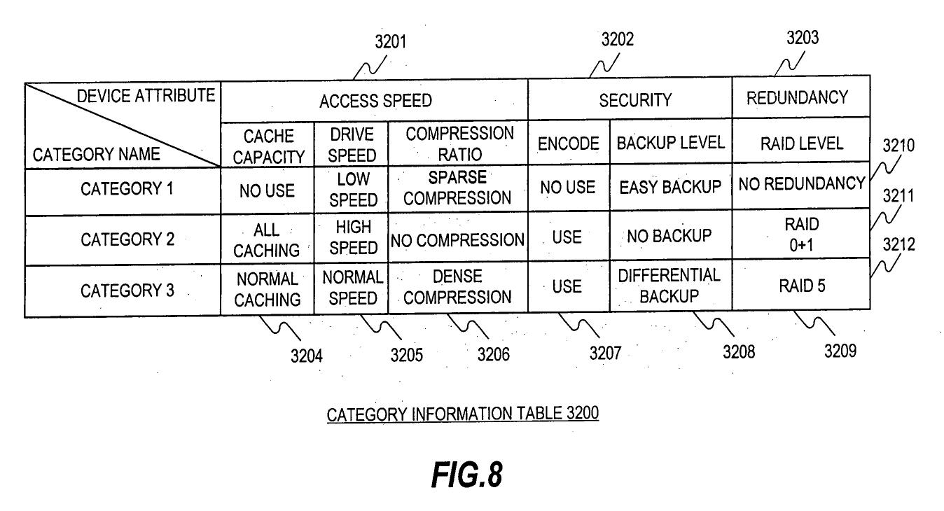

FIG. 8 is an explanatory diagram showing the category information table 3200 in the embodiment of this invention.

The category information table 3200 is composed of a device attribute and a category name 3240.

The device attribute includes of an access speed 3201, a security 3202, and a reliability 3203.

The access speed 3201 stores the information to determine the access speed required for the category. The information to determine the access speed includes a cache capacity 3204, a drive speed 3205, and a compression ratio 3206.

The security 3202 stores the information to determine a level of the security required for the category. The information to determine the level of the security includes an encode 3207 and a backup level 3208.

The reliability 3203 stores the information to determine the reliability required for the category. The information to determine the reliability includes a RAID level 3209. The content of the category can be obtained by referring to this category information table 3200.

Concretely, for example, with regard to the category 1 3210 of FIG. 8, in the access speed 3201, the cache capacity 3204 is set for “Non Use”, the drive speed 3205 is set for “Low Speed”, and the compression ratio 3206 is set for “No Compression”, respectively. Also, in the security 3202, the encoding method 3207 is set for “No Use”, and the backup level 3208 is set for “Easy Backup”, respectively. Also, in the reliability 3203, the RAID level 3209 is set for “Non Redundancy”.

It should be noted that the information of the category stored in this category information table 3200 is preset and shared by the entire storage system.

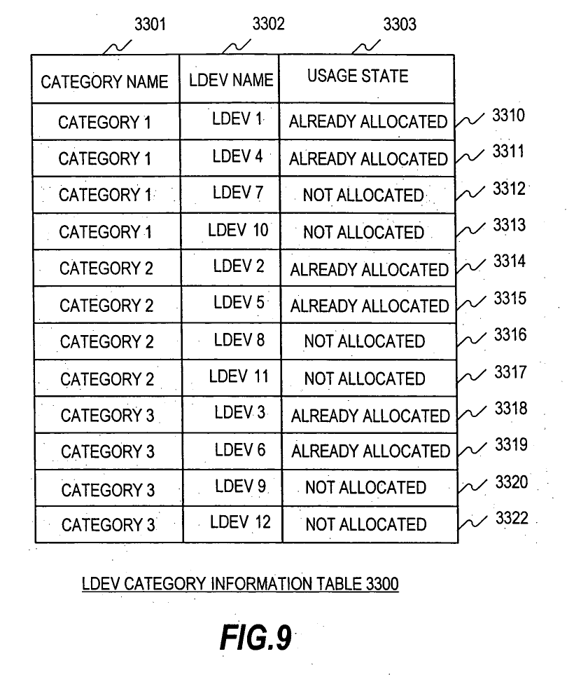

FIG. 9 is an explanatory diagram showing the LDEV category information table 3300 in the embodiment of this invention.

The LDEV category information table 3300 is composed of a category name 3301, an LDEV name 3302, and a usage state 3303.

The category name 3301 stores an identifier of the category, and the LDEV name 3302 stores an identifier of the LDEV.

The usage state 3303 stores an identifier as to whether or not the LDEV is already used.

For example, in an entry 3310 of FIG. 9, an LDEVL set as the category 1 indicates that the usage state 3303 is “Already Allocated”, in other words, the LDEV 1 is already allocated to the LU and used. Also, in an entry 3312, an LDEV7 set as the category 1 indicates that the usage state is “Not Allocated”, in other words, the LDEV 7 is not allocated to any LUs.

When setting a new database area, the database management system 20 can refer to this LDEV category information table 3300 and obtain the LDEV corresponding to the category used in the database area.

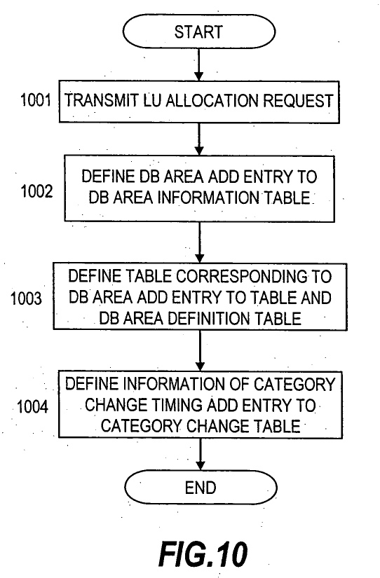

FIG. 10 is a flowchart of a table register process of the database management system 20 in the embodiment of this invention.

The application of the AP server 10 transmits a category register request including category names requested by the application, the order thereof, and timing information of a category change to the database management system 20. When the database management system 20 receives this category register request, the process of this flowchart is started.

The category register request transmitted by the application is received by the request receipt/reply return unit 201. The request receipt/reply return unit 201 transmits the received category register request to the process control unit 202. The process control unit 202 transmits the received category register request to the category information edit unit 203. The processes on and after of this flowchart are executed by this category information edit unit 203.

The category information edit unit 203 obtains the information of the category names, the order thereof, and the category change timing, from the information included in the received category register request.

The category information edit unit 203 uses the obtained category name and the order, and generates an LU allocation request. Then, the category information edit unit 203 transmits the LU allocation request to the storage management unit 30 (a step 1001).

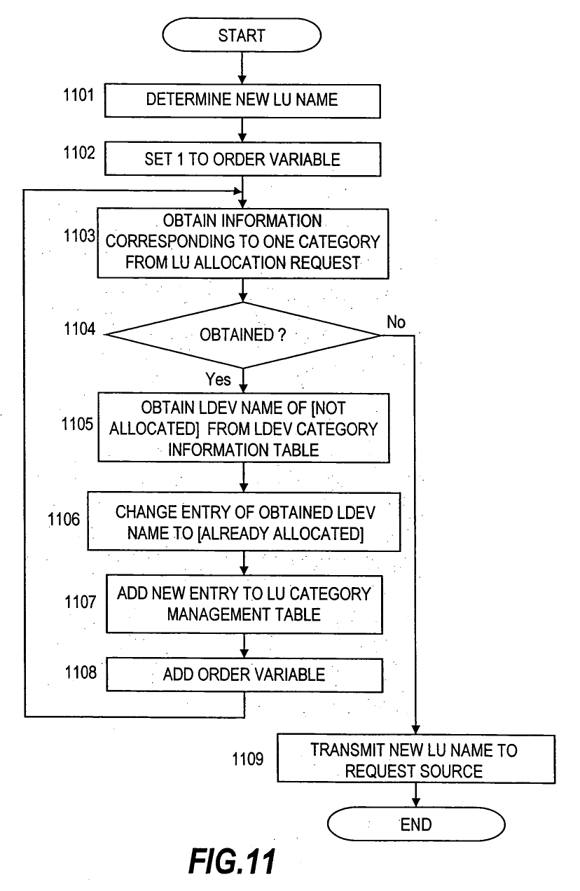

The storage management unit 30 receiving this request executes the LU allocation process shown after in FIG. 11. As the result of this LU allocation request, an entry of a new LU corresponding to the request is stored in the LU category management table 3100 of the storage management unit 30. The storage management unit 30, transmits the identifier of this new LU to the database management system 20.

Next, the category information edit unit 203 correlates the received LU identifier to the database area storing the table of the database used by the application and defines database area information. Then, the category information edit unit 203 adds the defined database area information as the new entry of the DB area information table 2300 (a step 1002).

Next, the category information edit unit 203 correlates the defined database area to the table of the database used by the application and defines table and DB area information. Then, the category information edit unit 203 adds the defined table and DB area information as the new entry of the table and DB area definition table 2200 (a step 1003).

Next, the category information edit unit 203 correlates the obtained category change timing to the application and defines category change timing information. Then, the category information edit unit 203 adds the defined category change timing information as the new entry of the category change table 2100 (a step 1004).

The foregoing processes newly define the information corresponding to the tables of the databases used by the application. The defined information is stored as the new entry in each of the LU category management table 3100, the DB area information table 2300, the table and DB area definition table 2200, and the category change table 2100.

FIG. 11 is a flowchart of the LU allocation process of the storage management unit 30 in the embodiment of this invention.

At a step 1001 of FIG. 10, when the storage management unit 30 receives the LU allocation request transmitted from the database management system 20, the process of this flowchart is started.

In the storage management unit 30, the category control unit 302 receives this LU allocation request and executes the process.

At first, the category control unit 302 obtains the received content of the LU allocation process. Then, it determines a new LU name that is the identifier of the allocated LU (a step 1101).

Next, the category control unit 302 sets 1 to an order variable (a step 1102). This order variable is used in order to sequentially obtain the category information included in the LU allocation request.

Next, the category control unit 302 obtains the information corresponding to one category from the received LU allocation request (a step 1103). Then, whether or not the information of the category can be obtained is judged (a step 1104). If the category information can be obtained, the process proceeds to a step S1105. If the category information cannot be obtained, in other words, if all of the category information is obtained, the process proceeds to a step 1109.

At the step 1105, the category control unit 302 refers to the LDEV category information table 3300 and obtains the LDEV name in which the usage state 3303 of the category is “Not Allocated”, among the category names of the obtained category information.

Next, the category control unit 302 changes the usage state 3303 of the obtained LDEV name to “Already Allocated” (a step 1106).

Next, the category control unit 302 adds the new entry to the LU category management table 3100 (a step 1107). This entry includes the new LU name determined at the step 1101, the category names of the category information obtained at the step 1103 and the order thereof, and the LDEV name obtained at the step 1105.

Next, 1 is added to the value of the current order variable (a step 1108). Then, the process returns to the step 1103.

At the step 1109 the category control unit 302 transmits the new LU name determined at the step 1101 to a request transmission source of the LU allocation request, and the fact of the completion of the LU allocation request is reported.

The foregoing processes, the LU in accordance with the LU allocation request of the database management system 20 is set for the storage management unit 30.

The processes of the access to the database carried out by the application of the AP server 10 will be described below.

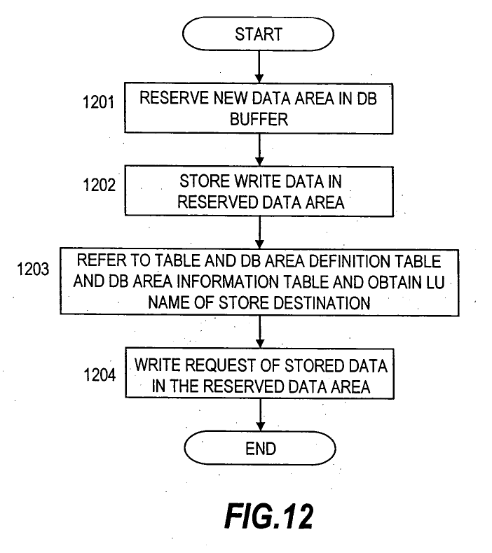

FIG. 12 is a flowchart of the data insertion process of the database management system 20 in the embodiment of this invention.

The application of the AP server 10 transmits a data insertion request for inserting new data into a table of the database to the database management system 20. When the database management system 20 receives this database insertion request, the process of this flowchart is started.

The data insertion request transmitted by the application is received by the request receipt/reply return unit 201. The request receipt/reply return unit 201 transmits the received data insertion request to the process control unit 202. The processes on and after of this flowchart are executed by this process control unit 202.

When receiving the data insertion request, the process control unit 202 reserves a new data storage area in the DB buffer 205 (a step 1201). Concretely, the process control unit 202 transmits the request for reserving the data storage area to the DB buffer management unit 204. The DB buffer management unit 204 receiving this request reserves the data storage area in an empty area of the DB buffer 205.

Next, the process control unit 202 obtains insertion data included in the data insertion request and stores in the reserved data storage area (a step 1202).

Next, the process control unit 202 obtains the information of the table of the insertion destination of the data insertion request. At first, the process control unit 202 refers to the table and DB area definition table 2200 and obtains a database area name corresponding to the obtained table. Next, the process control unit 202 refers to the DB area information table and obtains an LU name corresponding to the obtained database area (a step 1203).

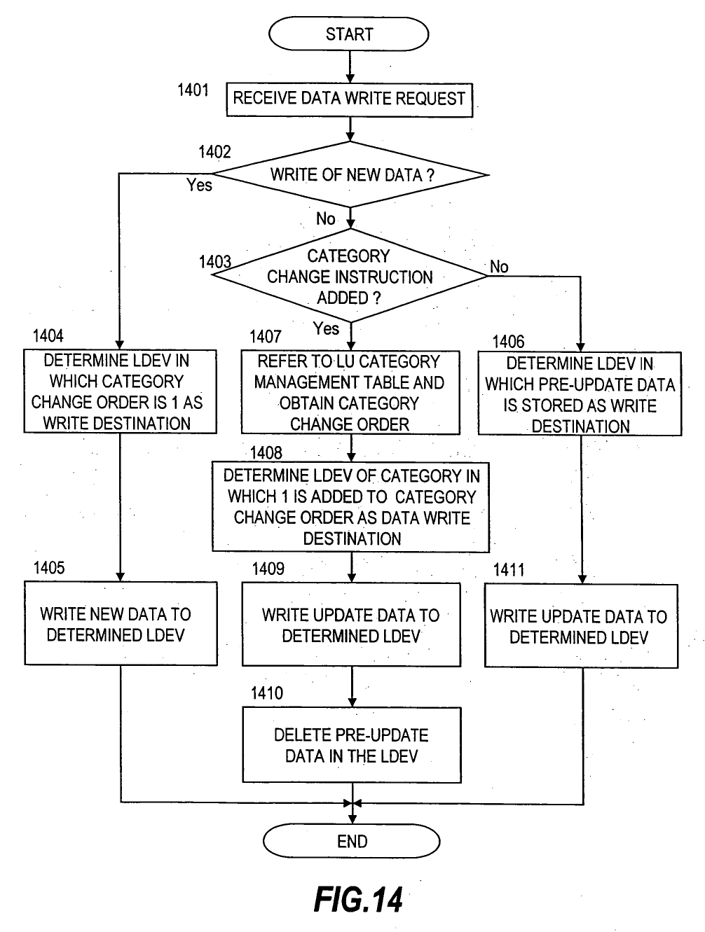

Next, the process control unit 202 transmits the write request of stored data in the reserved data storage area, in which the obtained LU name is the write destination, to the storage management unit 30 (a step 1204). The storage management unit 30 receiving this request executes a data write process shown in FIG. 14 and stores the write data in the storage system.

The foregoing processes, the data insertion request from the application is processed, and the insertion data is stored in the LU that is the data storage area of the storage system 40.

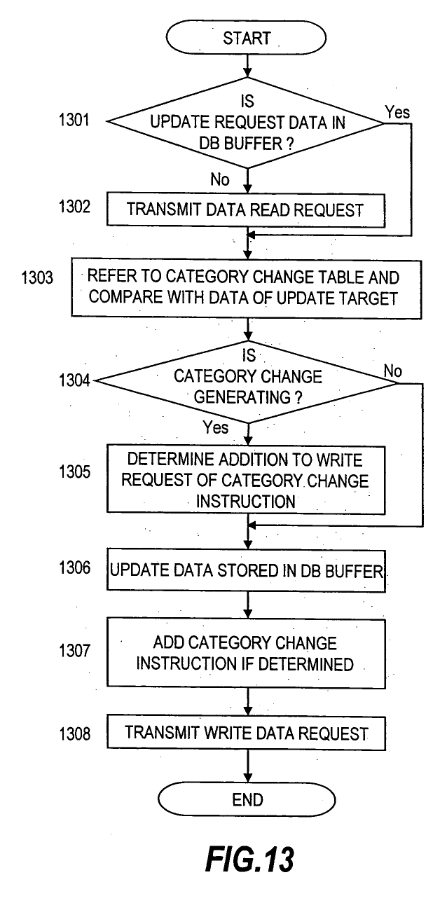

FIG. 13 is a flowchart of the data update process of the database management system 20 in the embodiment of this invention.

The application of the AP server 10 transmits a data update request for updating data already existing in the table of the database to the database management system 20. When the database management system 20 receives this database update request, the process of this flowchart is started.

The data update request transmitted by the application is received by the request receipt/reply return unit 201. The request receipt/reply return unit 201 transmits the received data update request to the process control unit 202. The processes on and after of this flowchart are executed by this process control unit 202.

When receiving the data update request, the process control unit 202 firstly judges whether or not the DB buffer 205 stores the data corresponding to the update request, in other words, pre-update data (a step 1301). Concretely, the process control unit 202 transmits an inquiry as to whether or not the data is stored, to the DB buffer management unit 204, and carries out the judgment in accordance with the result.

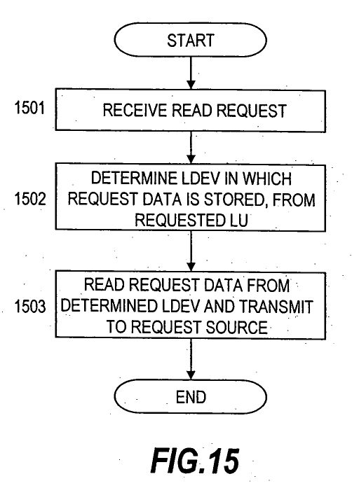

If the data is judged not to be stored, the process control unit 202 gives the data to the storage management unit 30 and transmits a data read request (a step 1302). The storage management unit 30 receiving this request executes a data read process shown in FIG. 15 and returns the data corresponding to the request to the database management system 20. This data is stored in the DB buffer 205.

If the data is judged to be stored in the DB buffer, the process proceeds to a step 1304 without any execution of the step 1302.

Next, the process control unit 202 refers to the category change table 2100 and judges whether or not the application name of the data update request source and the table and row to which the update data belongs are coincident with the entry of the table (a step 1303). As this judged result, whether or not they are coincident with the entry of the category change table 2100 and whether or not the data update request of the application is the operation inducing the category change generating are judged (a step 1304).

If the data update request is judged to be the operation inducing the category change generating, when the request for writing the update data stored in the DB buffer 205 to the storage management unit 30 is transmitted, the process control unit 202 determines the addition of the category change instruction (a step 1305).

If the data update request is judged not to be the operation inducing the category change, the process proceeds to a step 1306 without any execution of the step 1305.

Next, the process control unit 202 updates the pre-update data stored in the DB buffer 205, in accordance with the data update request (a step 1306).

Next, the process control unit 202 generates the data write request to be transmitted to the storage management unit 30 (a step 1307). At this time, if the addition of the category change instruction is determined at the step 1305, the process control unit 202 adds the category change instruction to the generated data write request.

Next, the process control unit 202 transmits this data write request to the storage management unit 30 (a step 1308). The storage management unit 30 receiving this write request executes the data write process shown in FIG. 14 and stores the write data in the storage system.

The foregoing processes, the data update request from the application is processed, and the pre-update data stored in the LU that is the data storage area of the storage system 40 is updated.

FIG. 14 is a flowchart of a data write process of the storage management unit 30 in the embodiment of this invention.

At the step 1204 of FIG. 12 or the step 1308 of FIG. 13, when the storage management unit 30 receives the data write request transmitted from the database management system 20, the process of this flowchart is started.

In the storage management unit 30, the data read/write control unit 301 receives this data write request and executes the process of this flowchart.

When receiving the data write request (a step 1401), the data read/write control unit 301 judges whether the request data for writing is a new data or an update of data (a step 1402). If the request data for writing is the new data, the process proceeds to a step 1404. If the request data for writing is the update of the data, the process proceeds to a step 1407.

At the step 1404, the category control unit 302 refers to the LU category management table 3100 and obtains the LDEV, in which the category change order is “1”, among the LDEVs belonging to the LU corresponding to the write request. Then, the category control unit 302 determines the obtained LDEV as the data write destination. Then, the category control unit 302 writes the new data to the determined LDEV (a step 1405).

On the other hand, at the step 1403, whether or not the category change instruction is added to the data write request is judged. If the category change instruction is judged to be added, the process proceeds to a step 1407. If the category change instruction is judged not to be added, the process proceeds to a step 1406.

At the step 1406, the category control unit 302 determines the LDEV, in which the pre-update data of the update data is stored, as the data write destination. Then, the category control unit 302 writes the update data to the determined LDEV (a step 1411).

On the other hand, at the step 1407, the category control unit 302 refers to the LU category management table 3100 and obtains the category change order of the LDEV in which the pre-update data of the update data is stored.

Next, the data read/write control unit 301 obtains the LDEV corresponding to the category change order in which “1” is added to the obtained category change order. Then, the data read/write control unit 301 determines the obtained LDEV as the data write destination (a step 1408). Then, the data read/write control unit 301 writes the update data to the determined LDEV (a step 1409).

When the writing of the update data has been completed, the data read/write control unit 301 deletes in the LDEV in which the pre-update data is stored, in other words, the pre-update data stored in the LDEV corresponding to the category prior to the category change.

The foregoing processes, the data corresponding to the write request from the database management system 20 is stored in the storage system. At this time, if the category change request is added, the update data is stored in the LDEV of the category specified in the next order of the category of the pre-update data.

FIG. 15 is a flowchart of the data read process of the storage management unit 30 in the embodiment of this invention.

At the step 1302 of FIG. 13, when the storage management unit 30 receives the data read request transmitted from the database management system 20, the process of this flowchart is started.

In the storage management unit 30, the data read/write control unit 301 receives this data read request and executes the process of this flowchart.

When receiving the data read request (a step 1501), the data read/write control unit 301 transmits the request for reading data to the category control unit 302. The category control unit 302 refers to the LU category management table 3100, obtains the LDEV corresponding to the LU corresponding to the request, and determines the LDEV of the read destination (a step 1502).

Then, the data read/write control unit 301 reads the request data from the determined read destination LDEV. Then, the data read/write control unit 301 transmits the read data to the database management system 20 of the read request source (a step 1503).

The foregoing processes, the read request data is read from the storage system 40.

In the computer system of the embodiment of this invention as explained above, in accordance with the flow of the processes of the work flow of the application, the LDEV allocated to the LU of the storage system can be changed to the different category (attribute). The timing of the category change is determined by the process content and process target of the application.

A variation of the embodiment of this invention will be described below.

With the foregoing embodiment is designed such that the storage management unit 30 changes the LDEV allocated to the LU, if there is the category change instruction from the database management system 20. In other words, if there is the category change instruction the storage management unit 30 refers to the LU category management table 3100 and allocates the LDEV of the category of the next category change order to the LU.

In contrast, in the variation of the embodiment of this invention, the storage management unit 30 changes the category itself of the LDEV allocated to the LU, if there is the category change instruction from the database management system 20.

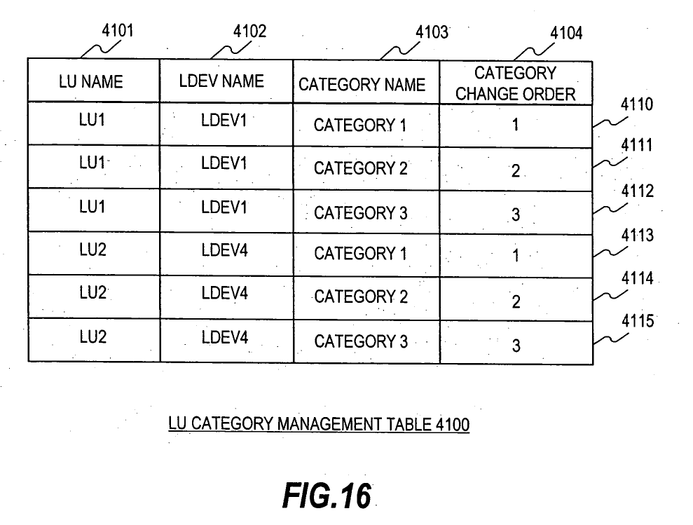

FIG. 16 is an explanatory diagram showing an LU category management table 4100 of the variation in the embodiment of this invention.

The LU category management table 4100 has the same configuration as that of the foregoing LU category management table 3100.

However, the LDEVs represented by an LDEV name 4102 are all equal in the same LU. In other words, the number of the LDEVs allocated to the LU is one. In association with the category change, the category itself of the allocated LDEV is changed.

When receiving the category change instruction from the database management system 20, the data write process 160 of the storage management unit 30 changes the category of the access destination, in accordance with this category change order. Then, in association with the category change, the category of the LDEV of the write target of the data is changed.

The request of the access destination to the database from database management system 20 is instructed as the LU. This LU is allocated to the LDEV indicated in this LU category management table 3100 by the storage management unit 30. If the database management system 20 transmits the category change instruction, the category of the LDEV is changed in accordance with the category change order. As a result, without changing the LU that is the access target from the database management system 20, by changing the category of the LDEV, it is possible to change the attribute of the LDEV without changing the allocation of the plurality of LDEVs.

This variation is used, for example, in the case where the data is stored close to the upper limit of the capacity of the LDEV of archive storing the process history of the application or the like. In other words, in the data that needs to be stored for a long time although the request of the access speed is low, the category of the LDEV itself storing the data is changed. For example, the category is changed to the category in which the capacity is large and the reliability is high although the access speed request is low, and this is defined as an archive. Then, a new LDEV for storing the process history in real time is separately prepared. Thus, it is possible to correspond to a life cycle of the database.

While the present invention has been described in detail and pictorially in the accompanying drawings, the present invention is not limited to such detail but covers various obvious modifications and equivalent arrangements, which fall within the purview of the appended claims.

What is claimed is:

1. A storage management unit for controlling to read/write data from/to a storage unit for storing the data, the storage unit is comprised a data storage area including a plurality of logical devices for which different attributes are set, the storage management unit comprising:
a read/write control unit for controlling to read/write the data from/to the storage unit, in accordance with a received access request; and
an attribute control unit for setting attributes of the logical devices, wherein:
when detecting a change timing of an attribute of the data stored in the storage unit, the attribute control unit moves the data corresponding to the attribute change to a logical device of a different attribute.

2. The storage management unit according to claim 1, wherein the attribute control unit detects an attribute change timing generated in response to an advancement of an application program for sequentially executing a plurality of processes to a database and moves the data corresponding to the attribute change to the logical device of the different attribute.

3. The storage management unit according to claim 1, wherein the attribute of the logical device includes at least one of an access speed, safety, and reliability of the logical device.

4. A computer system, comprising:
an application server for sequentially executing a plurality of processes to a database;
a storage unit for storing the database;
a database management unit for managing the database, in accordance with the process by the application server; and
a storage management unit for controlling to read/write data from/to the storage unit, in accordance with a request from the database management unit, wherein:
the storage unit is comprised a database storage area including a plurality of logical devices for which different attributes are set;
the database management unit includes
a process request reception return unit for receiving the request from the application server and returning a result of a process, and
a process control unit for executing the process in accordance with the request from the application server;
the storage management unit includes
a read/write control unit for controlling to read/write data from/to the storage unit, in accordance with the request from the database management unit, and
an attribute control unit for setting attributes of the logical devices;
when a process content and a process target by the application server satisfy a predetermined condition, the process control unit transmits an attribute change instruction for changing the attributes of the logical devices to the storage management unit, and
when receiving the attribute change instruction from the database management unit, the attribute control unit changes the attribute of a logical device, in which the data of the process target by the application server is stored, to a different attribute.

5. The computer system according to claim 4, wherein the process control unit specifies the process executed by the application server, in accordance with the process target of the application server, and specifies the logical device in which the data of the process target is stored.

6. The computer system according to claim 4, wherein, when receiving the attribute change instruction from the database management unit, the attribute control unit changes the attribute of the logical device, in which the data of the process target of the application server is stored, to the different attribute by moving the data corresponding to the attribute change instruction to the logical device of the different attribute.

7. The computer system according to claim 4, wherein, when receiving the attribute change instruction from the database management unit, the attribute control unit consequently changes the attribute of the logical device, in which the data of the process target of the application server is stored, to the different attribute by changing the attribute of the logical device allocated to the database storage area to the different attribute.

8. A storage management method in a computer system including:
an application server for sequentially executing a plurality of processes to a database;
a storage unit for storing the database;
a database management unit for managing the database, in accordance with the process by the application server; and
a storage management unit for controlling to read/writing data from/to the storage unit, in accordance with a request from the database management unit, the storage unit is comprised a database storage area including a plurality of logical devices for which different attributes are set,
the method comprising the steps of:
receiving the request from the application server;
transmitting an attribute change instruction for changing the attributes of the logical devices to the storage management unit, if a process content and a process target by the application server satisfy a predetermined condition;
reading and writing the data from/to the storage unit, in accordance with the request from the database management unit;
when receiving the attribute change instruction from the database management unit, changing the attribute of a logical device, in which the data of the process target of the application server is stored, to a different attribute; and
returning a result of the process to the application server.

9. The storage management method according to claim 8, further comprising specifying the process executed by the application server, in accordance with the process target of the application server, and specifying the logical device in which the data of the process target is stored.

10. The storage management method according to claim 8, the steps of changing the attribute of the logical device to the different attribute comprising, moving the data corresponding to the attribute change instruction to the logical device of the different attribute, when the attribute change instruction is received from the database management unit.

11. The storage management method according to claim 8, the steps of changing the attribute of the logical device to the different attribute comprising changing the attribute of the logical device allocated to the database storage area to the different attribute, when the attribute change instruction is received from the database management unit.

12. The storage management method according to claim 8, wherein the attribute of the logical device includes at least one of an access speed, safety, and reliability of the logical device.

13. A program in a storage management unit for controlling to read/write data from/to a storage unit for storing the data, the storage unit is comprised a data storage area that includes a plurality of logical devices for which different attributes are set, to execute the procedures of:
reading and writing the data from and to the storage unit, in accordance with a received access request; and
moving the data corresponding to the attribute change to a logical device of a different attribute, when detecting a change timing of an attribute of the data stored in the storage unit.
